(19) United States
(12) Patent Application Publication
(10) Pub. No.: US 2018/0197189 A1
(43) Pub. Date: Jul. 12, 2018

(54) System and Method for Profiling Media

(71) Applicant: Veritonic, Inc., Killingworth, CT (US)

(72) Inventors: Andrew Eisner, Chappaqua, NY (US); Kevin Marshall, Gillette, NY (US); Scott Simonelli, Killingworth, CT (US)

(73) Assignee: Veritonic, Inc., Killingworth, CT (US)

(21) Appl. No.: 15/863,904

(22) Filed: Jan. 6, 2018

Related U.S. Application Data
(60) Provisional application No. 62/443,154, filed on Jan. 6, 2017.

(51) Int. Cl. G06Q 30/02; G06N 7/00; H04N 21/442; H04N 21/475

(52) U.S. Cl. CPC G06Q 30/0203; G06N 7/00; G06Q 30/0245; H04N 21/4756; H04N 21/44218

(57) ABSTRACT

Disclosed is a method and system for evaluating media files for use in marketing and advertisements. An audio segment is provided to a number of survey participants. Each survey participant reviews the media file and selectively inputs perceived psychological attributes and their degree. This information is timestamped and recorded, and then combined with other survey participants' responses to compile a score for a variety of psychological attributes which tend to be invoked by the media file. The user may view a dashboard and which indicates the results for their media file relative to a set of media files, so that the user, may, for instance, select media files displaying certain criteria. In certain embodiments, objective data regarding media segments as well as past rated media files may be used to predict scoring for new media files.

### CROSS REFERENCE TO RELATED APPLICATION

The present application claims benefit to U.S. Provisional Patent Application No. 62/443,154 filed Jan. 6, 2017 and titled “System and Method for Profiling Media.” The contents of U.S. Prov. Pat. App. No. 62/443,154 are hereby incorporated herein in their entirety.

### FIELD OF THE INVENTION

Disclosed is system a system and method for providing a quantitative measurement of the psychological attributes and other associations that individuals have for individual media elements of marketing media, as well as a comparison between such materials.

### BACKGROUND

Prior to disclosed system marketers had no quantitative framework for evaluating how well the audio and other media in marketing supported the goals of the individual marketing efforts. Instead, music and other media elements were chosen based solely on the opinion of the marketers, using subjective criteria.

There are a variety of solutions for evaluating and predicting how completed ads will perform. However, these solutions typically involve in-person focus groups, providing feedback on the ad unit in its entirety: e.g. the visual with the music and any associated voiceover. Solutions involving online focus groups similarly depend on showing the entire advertising asset to a group of individuals, and assessing their response using a variety of technologies: questionnaires, facial recognition, etc. These solutions do not specifically evaluate the effectiveness of the audio elements in the ad and how well the audio elements support the overall message of the ad.

There are also solutions for evaluating music on its own, but these are all focused on whether the music will appeal to audiences for consumption as part of an entertainment experience. The users of these services want to know, for instance, “will this song become a hit?” or “does this song need more guitar?”

In fact, many other aspects of advertising besides the audio get evaluated by the marketer prior to the advertising being used. For example, data is applied to the core creative concept, in the form of a focus group, which is almost never of the size to reveal statistically significant measurements. If appropriate, the visuals get tested, the copy is tested, the ad buy is informed by data, and the size and composition of the audience that sees or hears the ad is measured. Even the choice of colors is informed by data.

For online advertising, the use of data is even more pervasive: the ad units may be A/B tested, the audience is micro-targeted, and the viewability of the ad is measured more and more frequently.

However, data related to the marketing media (audio, video) itself is elusive. Music and audio particularly have characteristics that defy easy categorization and measurement, and addressing these issues is complex and time-consuming. Music in particular can be highly subjective. For example, individuals often have special memories associated with particular songs not shared by anyone else. These experiences lead individuals to make decisions that may not reflect the tastes and associations of the audience the marketer is trying to reach. The application of psychological framework to music is in the nascent stages, as research is beginning to be undertaken to reveal how music impacts the brain.

Audio also has a temporal component that makes it unique. It must be consumed over a period of time, unlike an image or text. Music is also frequently asked to evoke different emotions at different times throughout an ad: for example, happy for the first ten seconds, then nervous for the next ten seconds, before resolving to an even happier state for the last ten seconds.

The format of audio also defies easy categorization and manipulation. In advertising, usually audio files are stored as a collection of .MP3 files, which is a file format designed for compression, not easy categorization. Even at the most sophisticated agencies, audio segments are frequently stored in a folder in the iTunes account of the music supervisor, or the creative director, for example. Formats and storage options such as these don't lend themselves to sorting, discovery or collaboration.

To the extent that there is data to facilitate the selection of music for advertising, it is in the form of “metadata”. These are simple tags added by a user that list the artist, title, date of creation, and in some instances the owners of the tracks' copyrights. Such metadata is typically concerned with the administration and usage of the music, rather than anything useful to help select it.

In certain instances, metadata is categorized according to the ID3 format, which provides for a more formal categorization of the title, author, year of creation and similar items than is apparent from a file's name. Music libraries or online aggregators and resellers often try to augment basic metadata by manually having works add simple generalizations about the music, such tempo or beats per minute, genre, and instrumentation. They may also try to categorize the “mood” of the music, boiling down the entire piece to a single “emotion.” These tags have many of the same issues as metadata: they are the output of a single person's perceptions of the emotion, who almost certainly doesn't represent the target audience that the advertiser or user of the music is trying to reach.

Meanwhile, data for other forms of audio are essentially non-existent. Voiceover, audio logos and even completed ads, each have many of the above mentioned limitations applicable to music, but also suffer from a general lack of even rudimentary data standards such as those in place for music.

Testing can address all of these shortcomings, and give data that far exceeds these limitations. Advanced psychological frameworks can give insight about how people respond to the audio stimulus. And built-to-purpose audiences—that match the audiences marketers are trying to reach—can give their opinions about the audio, revealing the emotional texture of a piece of audio, while also informing the marketers and composers about how well the assets support the story the marketer is trying to tell.

Therefore, a need exists to help marketers understand how their audiences will react to the audio elements of advertising, and whether that audio successfully evokes the response that the marketer is trying for.

### BRIEF DESCRIPTION

The disclosed system and method include a series of components designed for capturing and interpreting feedback from audiences. The first component is a set of data collectors, or configurable interfaces, that can be presented to audience panelists through electronic devices: Such an electronic device may typically be a computer, but also any analogous electronic device such as a smartphone or tablet can be employed. These data collectors present a structured set of psychological attributes to audience panelists, who track their psychological attributes, and the associated strength of the psychological attributes, by clicking on the data collectors in real time as they are presented the media segment. The data collectors are randomly and regularly rotated to ensure that no bias is introduced into the data from the type of data collector being presented for a specific evaluation. The ordering of the psychological attributes within the data collector is also randomly and regularly rotated to similarly prevent bias in the responses. Consequently, the data collectors produce a novel set of Marketing Response Data, tightly correlating psychological attributes on a second-by-second basis to the audio. While generally, the examples provided in the present application relate to audio in advertisements, the invention is not limited to this context, and in fact, can be employed to evaluate and select media segments for many purposes, marketing and otherwise.

The Marketing Response data from the data collectors is then fed into a processing platform, which evaluates the responses, the frequency and amplitude of responses, and the timing of responses, in conjunction with other factors, to present both individual and overall scores for each piece of audio being evaluated. Users are then able to compare the audio tracks being evaluated on a like-for-like basis. Demographic and psychographic data points that are collected in the audience selection and playback process may also be used to further segment and identify responses by relevant groups to the audio stimuli. Individual tracks may also be compared on a whole-track basis, on a segment-by-segment or even second-by-second basis for additional insight.

### BRIEF DESCRIPTION OF THE DRAWINGS

FIG. 1 depicts an embodiment data collector as presented on the display of an electronic device.

FIG. 2 depicts a second embodiment data collector as presented on the display of an electronic device.

FIG. 3 depicts the selection of timestamp data, including score, time and psychological attributes data.

FIG. 4 depicts the display of sample results according to an embodiment method.

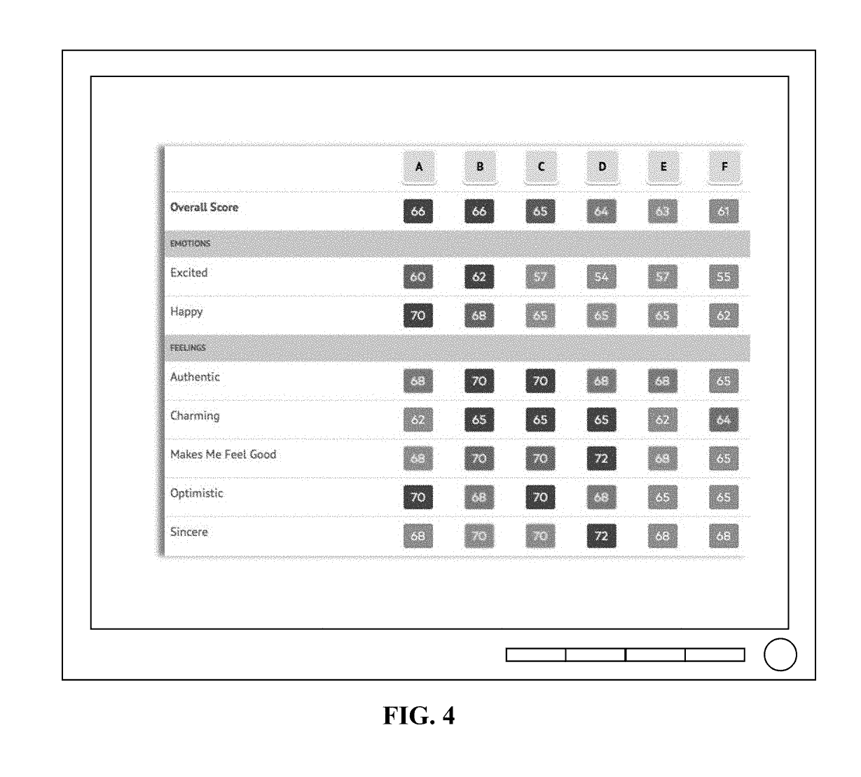

### DETAILED DESCRIPTION

In a first embodiment, numerous psychological attributes are tracked. These may, optionally, be characterized as emotions, which capture a visceral response from a survey participant, or feelings, which capture a more nuanced attribute. The psychological attributes elicited from a media segment are useful in advertising, marketing, and customer interactions. In the first embodiment, emotions include:
‘Happy’; ‘Relaxed’; ‘Excited’; ‘Bored’; ‘Calm’; ‘Engaged’; ‘Excited’; ‘Happy’; ‘Nervous’; ‘Relaxed’; ‘Sad’; and ‘Sleepy.’

Other emotions may be included. The attributes being tracked also include more nuanced feelings that may describe the specifics of what a brand is trying to evoke within a specific ad or campaign. In the first embodiment, these include:
‘Confident’; ‘Welcoming’; ‘Celebratory’; ‘Independent’; ‘Spontaneous’; ‘Approachable’; ‘Empowering’; ‘Innovative’; ‘Reputable’; ‘Trustworthy’; ‘Charming’; ‘Relieved’; ‘Confusing’; ‘Helpful’; ‘Likable’; ‘Unique’; ‘Makes me feel good’; ‘Memorable’; ‘Annoying’; ‘Inspiring’; ‘Makes Me Feel Good’; ‘Energetic’; ‘Optimistic’; ‘Playful’; ‘Sexy’; ‘Authentic’; ‘Simple’; ‘Reflective’; ‘Sophisticated’; ‘Sincere’; ‘Healthy’; ‘Relevant To Me’; ‘Feminine’; ‘Melancholy’; ‘Soothing’; ‘Uplifting’; ‘Nostalgic’; ‘Relevant to me’; ‘Thoughtful’; ‘Familiar’; ‘Relevant to Me’; ‘Assertive’; ‘Enjoyment’; ‘Modern’; ‘Creative’; ‘Stylish’; ‘Aspirational’; ‘Authoritative’; ‘Powerful’; ‘Professional’; ‘suspenseful’; ‘intriguing’; ‘intense’; ‘high quality’; ‘makes me want to watch’; ‘interesting’; ‘Interesting’; ‘easy’; ‘straightforward’; ‘closeness’; ‘ease’; ‘Pleasurable’; ‘Tasty’; ‘pleasurable’; ‘tasty’; ‘adventurous’; ‘ambitious’; ‘annoying’; ‘approachable’; ‘aspirational’; ‘assertive’; ‘authentic’; ‘authoritative’; ‘bold’; ‘celebratory’; ‘charming’; ‘confident’; ‘confusing’; ‘contented’; ‘cool’; ‘creative’; ‘discouraging’; ‘down to earth’; ‘dramatic’; ‘eccentric’; ‘edgy’; ‘empowering’; ‘energetic’; ‘enjoyment’; ‘everyday’; ‘fake’; ‘familiar’; ‘feminine’; ‘friendly’; ‘healthy’; ‘helpful’; ‘humorous’; ‘independent’; ‘innovative’; ‘inspiring’; ‘jarring’; ‘lighthearted’; ‘likable’; ‘makes me feel good’; ‘melancholy’; ‘mellow’; ‘memorable’; ‘modern’; ‘moving’; ‘nostalgic’; ‘nurturing’; ‘old’; ‘optimistic’; ‘pessimistic’; ‘playful’; ‘positive’; ‘powerful’; ‘professional’; ‘quirky’; ‘reflective’; ‘relaxed’; ‘relevant to me’; ‘reminiscent’; ‘reputable’; ‘serious’; ‘sexy’; ‘simple’; ‘sincere’; ‘soothing’; ‘sophisticated’; ‘spontaneous’; ‘stylish’; ‘thoughtful’; ‘timeless’; ‘trustworthy’; ‘unique’; ‘uplifting’; ‘upscale’; ‘vibrant’; and ‘welcoming.’

In the context of this application, media segments may include musical songs or tracks and excerpts thereof, voiceover, audio logos, or completed audio or video advertisements, chimes and other video or audio clips and recordings. These are useful in enabling marketing and for advertisers to make better selections of audio components, or more generally for improving interactions with customers.

Data Collectors

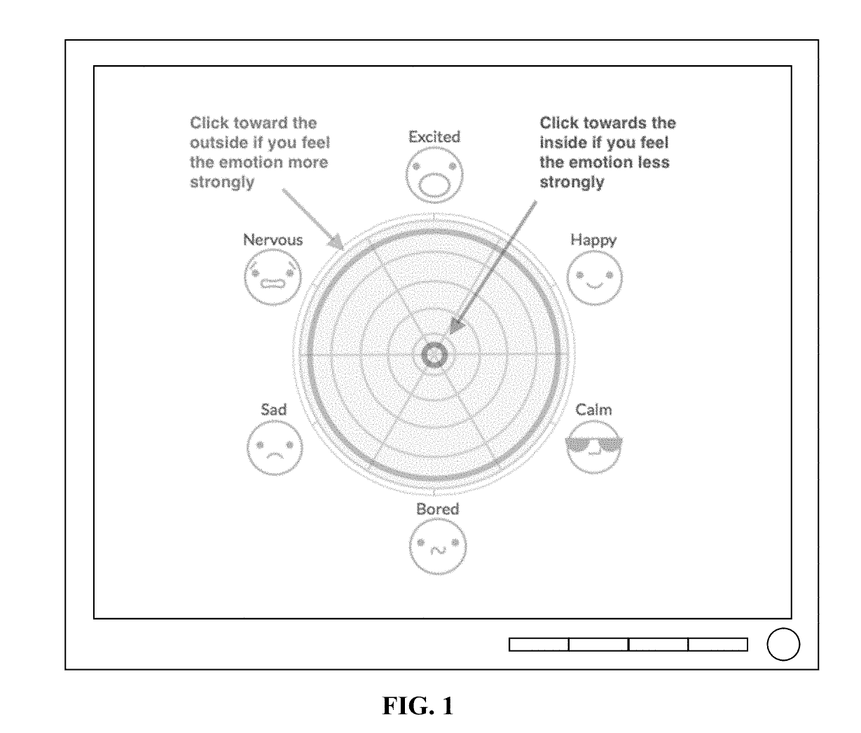

Data collectors may be presented to specific audiences in a number of configurations. These may optionally include “pie charts” as well as a “grid” structure or other forms of data collectors. With reference to FIG. 1, for the pie chart configuration, each slice of pie represents a psychological attribute. Users record the specific psychological attribute they are feeling by clicking on a target shaped like a slice of the pie that represents the psychological attribute they are feeling at that second. The audience panelist also records the strength with which they feel the psychological attribute, by clicking on a location within the pie slice that is designated a specific strength. Target locations toward the center of the circle represent feeling the psychological attribute more weakly. Conversely, target locations toward the outer rim of the pie or circle represent feeling the psychological attribute more strongly.

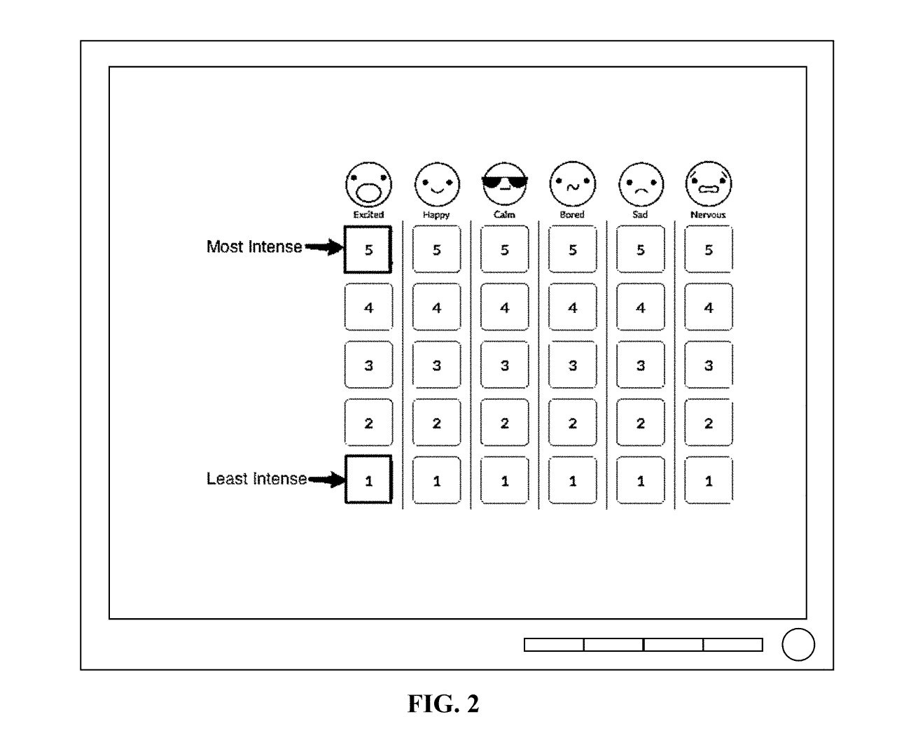

With reference to FIG. 2, for the grid data collector, a set of psychological attributes is displayed to the panelists in the form of a grid, with each psychological attribute having a respective column. Within the column, targets toward the top of the column represent feeling the psychological attribute more strongly, and targets toward the bottom represent feeling the psychological attribute less strongly.

The visual feedback given to the audience panelist varies depending upon the type of audiovisual stimuli they are being asked to respond to. With all data collectors, a click on a target changes the color of the target, to indicate that a click was recorded. The color of the change depends on how strongly the audience panelist feels the psychological attribute, with darker shades representing more strongly felt psychological attributes. Longer pieces of music, like a traditional song, generally elicit many feelings and changes of feeling throughout the duration of the music. Therefore, during a longer piece of music an individual click on a target will generate a temporary color change, before slowly reverting back to the color of the “unclicked” state. This signals to the audience panelist that their click has been recorded while inviting them to click again and record another psychological attribute. Shorter pieces of audio of less than 10 seconds, on the other hand, have fewer changes to report on. In this scenario the targets remain colored, in order to help facilitate the user giving feedback. In certain embodiments, multiple timestamped feedbacks (which serve as the subjective psychological attribute response data) will be received over the course of the playback of an audio segment. This can indicate, for example, the changing of a user's felt emotions over the audio segment or the consistency with which a particular emotion is felt. This data could, for instance, indicate that a particular sub-segment of the audio segment is desirable for a particular audience or purpose.

In the first embodiment, survey participants are presented with a structured set of the psychological attributes. These psychological attributes may optionally be six, but this number may be increased or decreased depending upon the requirements of a specific client.

Throughout a survey experience, an audience panelist is presented with a consistent set of psychological attributes, in a standardized order. However, the order of the psychological attributes changes from panelist to panelist in a random rotation in order to eliminate any bias from the testing methodology. Similarly, different audience panelists may receive different variations of the data collectors, in order to eliminate any methodology bias.

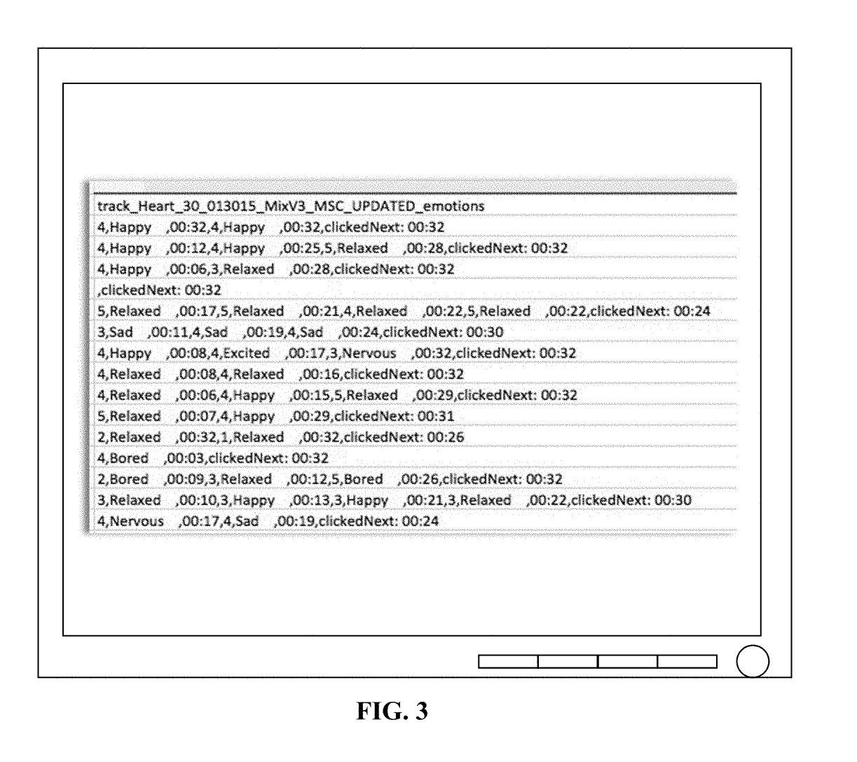

In addition to collecting the psychological attribute inputs (and in certain embodiments, feeling inputs) and associated intensity “timestamps”, the data collectors also record the time of each timestamp. The timestamp data is generated by allowing the browser to calculate and record the time in relationship to the individual user. These are generally recorded to the tenth of a second, but may also be recorded to the hundredth or even thousandth of a second in order to capture an appropriately fine-grained enough response to the audio. (See FIG. 3)

Once a small lag in audience panelist response time is accounted for, in order to allow for the audience panelist to hear and act on a given sound, the timestamp data allows the system to map the psychological attributes being recorded on a second-by-second basis to the audio stimuli, and thus to understand how changes in the assets—instrumentation, tonality, intonation of voices, accents, and so on—impact the psychological attributes being evoked.

Different types of timestamp data may also be recorded for different types of stimuli, depending on what the client is trying to accomplish. For instance, with longer pieces of music the specific timing of each timestamp may be recorded. For testing the recall of a specific piece of music, on the other hand, it is more relevant to track how quickly the user responds to the question being posed, and thus the system records both the timestamp and the elapsed time between when the audience panelist is exposed to the music and when they record their response. This feedback is used to produce a recall score.

In the first embodiment, for a given media segment, each survey participant is presented with the media segment twice. In the first presentation, the survey participant inputs data regarding the emotions that are elicited from the media segment, using the data collectors over time described above. In the second presentation, the survey participant inputs data regarding the feelings that are elicited from the media segment.

Data Processing

When a media segment is first ingested by the system, the system records several pieces of“objective data” about the music. This objective data includes but is not limited to things like the duration of the track. Using the characteristics of the music file, the system may also calculate other objective data points by evaluating the waveform and other characters. These additional data points include but are not limited to beats per minute, instrumentation, genre, key and specific notes.

The system may also calculate correlations between the demographics of audience panelists, the objective data calculated by the system, and the subjective emotional response data provided by audience panelists. Using these correlations (optionally via a variety of machine learning techniques, including a multinomial regression model), the system then predicts scores for specific psychological attributes and other subjective data points. When supplemented with additional limited sampling of data points from individuals, the system is able to reduce the sample needed to evaluate the audio or video.

Certain alternate embodiments, in addition to the collection of survey participant response data, also employ predictive models in order to score new media that has not yet, or will not, undergo the survey process. These predictive models may incorporate such features as objective demographic and psychographic data points and/or mathematical analysis as discussed in additional detail below. These predictions may advantageously be made accurate, not just in the aggregate, but also for specific audience populations that the user/marketer is trying to reach.

Furthermore, the system is able to augment traditional metadata with the system's Marketing Response Data. Giving the marketer or user of the system insight into how the desired audience is actually responding to the audio gives the marketer much more confidence about the audio elements to use for their purposes.

Data Interpretation

The system provides a visual dashboard that enables users to upload music and other media; to organize those media items into tests and auditions (a term for ad-hoc playlists and related data assembled from previously tested items); and to evaluate the results of any test or the results associated with an audition or even an individual track.

Results for most of the data can be presented in a tabular, color-coded format. The table structure presents the results for a single piece of media, or multiple pieces of media, along one axis, and the results on a dimension-by-dimension basis on the other axis. Different types of data are separated by graphical elements: for example, psychological attribute data, which is collected in a second-by-second basis, is visually differentiated from feelings and other associations data, which may be collected after the track or media has completed playing. Similarly, an overall score is presented which aggregates the scores of all the individual elements into a single number, and this overall score is visually segmented as well.

All data may be color-coded by row and dimension, with the top score in each row (representing a discrete dimension of data) colored dark green and the lowest score colored dark red. Scores in between are colored on a gradient between the two extremes. In cases where only a single data point is in a single row, as when a user is examining results for a single track, the data point is colored green.

The system may also color code scores according to all of the scores ever collected for that attribute and type of media. For instance, a specific song may have been evaluated for the feeling attribute “authentic.” Instead of the color scheme for the report reflecting only the tracks present on the screen, the color coding (green to red gradient) will reflect every “authentic” score ever recorded by the system for similar types of assets, in this case a piece of music. However, this contextual Scoring will not include scores for Authentic recorded for other types of media, like voiceovers and audio logos. In this way, the results of scoring will give the users context for a given score, i.e. Whether a specific score is good just in this instance or for every track ever tested.

Scoring, including the determination of a total score, can be accomplished with various methods, several embodiments of which are described below.

Embodiment Scoring Methodology

Now described is a scoring methodology according to an embodiment.

Overall Score

When gathering a feedback report from a survey participant, a total score can be calculated for the audio segment presented. Optionally, this calculation may take into account whether a user recalls the media segment being tested.

In one embodiment, where:

R=recall score

E=total emotional score

F=total feelings score

X=final score for the survey participant's feedback report

X=0.5*R+0.25*E+0.25*F

For instance, if R=50, E=70 and F=60, the score would be calculated as:

X=0.5*50+0.25*70+0.25*60=57.5

The calculation of the recall, emotion and feeling scores are described in additional detail below. In another embodiment, in which whether the user recalls the media segment is not being monitored, an overall score may be calculated as:

X=0.5*E+0.5*F

Other factors that may be taken into account in scoring:
1. Average time to recall (aided and unaided) may factor into weighting
2. Average time until the 1st emotional response may factor into the weighting of that emotion
3. Number of timestamps for each emotion may factor into weighting of that emotion
4. Number of timestamps overall
5. Percentage of panelists who give a score for a specific emotion

Recall Scoring

An average time to recall may be calculated as follows and used as a stand-alone number. First, the timestamps are expressed in milliseconds. An average aided recall time may be the sum of milliseconds to the number of yes responses. An average unaided recall time may be the sum of milliseconds to the number of yes responses.

One recall score is assigned per response. The recall score is a calculated percentage consisting of a count of the panelists who recall hearing a given track to the number of responses (multiplied by 100 to produce a percentage). For instance, if 50 Panelists out of 100 recall hearing a track, the score would be calculated as (50/100)*100=50. If aided recall is present, the score consists of the addition of the aided recall score and the unaided recall score.

Unaided recall is yes/no data converted on results upload. A yes response is converted to five and a no response gets converted to zero. Aided recall relies on matching specific brands identified by the panelists in the survey process when results are processed by the system. A match gets converted to a value of five, while “no match” gets converted to a value of zero.

Emotion Scoring

Multiple timestamps per response may be recorded. Embodiments may use several methods for calculation of averages.

For a straight average, first the average score per emotion per panelist response is determined as a sum of panelist's emotion scores divided by the number of panelists' responses for the particular emotion. This means each user ends up with one score per emotion they scored the track on (ex. a Happy score of 78). The average score per emotion is calculated as the sum of all panelists' emotion scores divided by the number of all panelists emotion scores. Therefore, each track ends up with one score per emotion scored on the track (ex. a Happy score of 76).

A weighted average may be determined by the average weight as if all emotions are ranked equal (i.e., 100 divided by the number of feelings then divided by 100. The average score per emotion is determined as the sum of panelist emotion scores divided by the number of panelist responses for the emotion. The top ranked emotion is given a weighted bump, if ranking is being employed.

For instance, the 1^{st}-ranked emotion may get a 25% bump in weight (i.e., average weighting per emotion plus the average weighting per emotion multiplied by 0.25). Then 75% is equally distributed amongst the rest.

In addition, the following factors may also be taken into account in scoring:
1. Determine the average time for first click of each emotion (sum of first timestamp for emotion divided by number of unique users who logged an emotion)
2. Average # of responses per emotion
3. Average cluster spot of emotions
4. Highest and lowest points for each emotion

Feelings Scoring

Optionally, this may include 1 score per response, per feeling, though alternatively multiple timestamps may associated with a feeling, with calculations performed similar to the emotions calculations described above.

A straight average or a weighted average may be employed. For the straight average, it is determined the average score per feeling, calculated as the sum of feeling scores divided by the number of feeling scores. This means each track ends up with one score per feeling on the track (ex. a Relaxed score of 83).

For a weighted average, it is determined the average weight as if all feelings are ranked equal, calculated as 100 divided by the number of feelings together divided by 100. If rankings are employed, the top three ranked feelings are given weighted bumps. Weighting may be employed as follows:
1st ranked is provided a 25% bump in weight (average weighting per feeling+(average weighting per feeling*0.25))
2nd ranked is provided a 20% bump in weight (average weighting per feeling+(average weighting per feeling*0.20))
3rd ranked is provided a 15% bump in weight (average weighting per feeling+(average weighting per feeling*0.15))
64% is equally distributed amongst the remaining feelings (average weighting per feeling−(0.64/(number of feelings−3)))

An example with 10 feelings weighted is provided below:
Average weight per feeling is 0.1
1st ranked feeling is weighted 0.125
2nd ranked feeling is weighted 0.120
3rd ranked feeling is weighted 0.115
Each remaining feeling is weighted 0.091

Additional Notes

Emotional data may be recorded in real time (as the user listens to the music with timestamps). There a user may supply zero responses for certain emotions on a given track. The user is required to supply at least one emotional response to each track. Scores with timestamps provide a unique “emotional texture” or signature to each track or piece of content we analyze.

Optionally, feeling data may be collected post-listen (after panelists have listened to a given track). Alternatively, feeling data may be collected in a “real time” manner similar to emotions data. This means exactly one score per feeling on each track may be collected. It may be required that each survey participant score all the feelings solicited for a given track. This ensures that each track/feeling in a given survey will have the same number of data points as all the other feelings from that track/survey.

Optionally, as part of the survey process subjective (i.e. generated by panelists) data may be collected regarding brands, musical artists and activities. Panelists may associate with a given track, and this may be used in the predictive algorithm. Subjective data (i.e. generated by panelists) may also be collected regarding the genre and instrumentation of each track and this data utilized in the predictive algorithm. In the first embodiment, demographic data points include age, gender, ethnicity, location, household income, and psychographic data points include whether the panelist is in the market for an automobile (“auto-intender”) or desires the latest technology, may also be collected from each panelist as well, and this data utilized in the predictive algorithm (described below).

In certain embodiments, the system has thresholds or baselines for each emotion or attribute. For example, the average Happy can be identified as 67 or a ‘good’ recall number may be 35). This can drive a contextual view within the interface, so users can quickly see if a given score is good or bad in relation to the system as a whole.

Users may also have access to a set of thresholds/baselines unique to their own specific “catalog” of media assets. This enables users to see scores in relation to only the other things in their own catalog of items.

In one embodiment, the context is based on the combination of the specific attribute (ex. happy) as well as the track type (ex. video/audio/audio logo). The context may also be changed based on the set of assets being compared. For instance, the assets may be compared with other assets in a given test; with assets across the user's account; or even across all of the System's assets. The assets being compared may also be from a given industry type, e.g. “Automotive” or “CPG/FMCG”; or may utilize specific objective characteristics, e.g. “female voices” or “guitars”.

The catalog view available to users of the system also incorporates the ability to view all of the assets uploaded by the user's account (typically, the user's company), as well as assets uploaded by other users of the system who have granted access to their assets to all users. Examples of these other users are publishers and other audio rights-holders, who may wish to expose their music and audio to a wider base of users. This may, for instance, allow a user to monetize their profile of media.

Minimum data collection thresholds may be applied to the emotions and feelings. For example, in one demonstrated embodiment these are set at 10%. This means that if at least 10% of panelists didn't report a score for a given emotion or feeling, that emotion or feeling will be presented as Not Significant (NS for short) and will not be counted in overall totals. Margin of error and statistical significance can also be calculated and used for certain functionality.

The above scoring is preferably made on a per-track basis. Two tracks that do not have the same attributes may also be compared. In one embodiment, tracks with fewer scored attributes [and high scores] will outscore tracks that have many scored attributes [with one or two low scores] because the multiple and low scores bring down the average. The process may involve adding in a weight or bonus for the overall count of scored attributes.

Context

The system may provide benchmarks regarding media segments to provide context as to their scoring relative to other content. For example, a user may view how a media segment performs for eliciting “Happy” as an emotion compared to all the other tested media segments in their own portfolio of media segments, or across some or all other users of the system, so that the user can determine whether their content is desirable for their purpose relative to their peers.

Predictive Algorithm

In certain embodiments, objective data is employed when determining the overall scores for an audio file. In this context, objective data includes values for BPM, tone, tempo, as well as what and when specific instruments are used.

Optionally, certain portions of the objective data may be subjectively collected, that is, collected from the panelists in the same manner as the emotional response data. Optionally, the system may collect and integrate objective data such as what instruments people believe they hear in real time.

Preferably, most objective data is collected using algorithmic processing of the audio files. For instance, one embodiment involves the Librosa and/or Yaafe open-source libraries. The objective data is associated to the related emotional response data and scores for each audio file. This may be done on a temporal basis. Historical data/scores may then be used to predict future attribute scores. For example, historical data may show that audio segments with guitars at a particular tempo and BPM for specified length of time score an average of 58 for happy.

Certain embodiment processes of providing predictive scores for a newly uploaded media segment are now described. First, each media segment in the System is broken down into sub-segments, preferably one second increments. Each media sub-segment is then fingerprinted. For example, for audio segments fingerprinting may employ techniques such as those described in the Dejavu Project, which is an open-source audio fingerprinting project in Python. One of ordinary skill in the art to which the present application pertains will appreciate the processes for fingerprinting media is known in various platforms.

In an embodiment finger printing process, the numerical data of each sub-segment of the media file is fed into a SHA-1 hash function. The resultant data string is then truncated. In the first embodiment, each sub-section hash is truncated to its first 20 characters. Each truncated sub-section hash is then compared to the truncated sub-section hashes of other audio segments on the system. The total number of matches between truncated sub-section hashes between two audio segments (i.e. files) is determined. This result can be compared to the total number of truncated sub-section hashes for the audio segment being analyzed. The percentage of matches between the media segment being analyzed and a potential similar media segment can be determined and use as a measure of whether the potential similar media segment is in fact similar.

In another embodiment, a Mel Frequency Cepstral Coefficient (MFCC) is calculated for each audio segment. This may be done either for the entire media segment, or by breaking the media segment into sections, in the first embodiment on a second-by-second basis. One of ordinary skill in the art to which the present application pertains will understand the known mathematical process of calculating a MFCC for a given media segment or sub-section thereof. The resultant MFCCs related to media segments for which there is already scoring (i.e., processed survey participant data), are compared to the MFCCs of newly added media segments, either as a whole or on a second-by-second basis. The known scores may be used to predict scoring for the newly added media segments.

Particularly, an attribute scoring vector is created for several psychological attributes, by retrieving the processed survey participant data relating to psychological attributes as described above for those media segments for which there is scoring data. In the embodiment, the attribute scoring vector may include any or all of the psychological attributes identified above, or may include other psychological attributes. The calculated MFCCs and attribute vector may either relate to entire media segment, or a on a sub-segment basis, for instance on a second-by-second basis.

In order to train a computer model to provide predictive results for further the MFCC and score vector details are input into a standard sklearn package, which is a well known data science package for python, in order to get a trained model:

clf=RandomForestClassifier( )

trained_model=clf.fit(mfccs, scores)

Where the entire media segment is analyzed, the resultant predictive coding can be quickly accomplished. However, breaking down the media segments into further subsegments has the advantage that more specific predictive data can be produced, so that, for instance, a portion of a media segment can be predictively coded differently than another portion of the same media segment.

Alternative embodiments employing Machine Learning Classification Models may employ a Naive Bayes classification model or multinomial logistic regression. In another alternate embodiment the predictive algorithm employed is a Deep Neural Net Machine Learning Model.

What is claimed:

1. A method of developing an evaluation of an audio file, comprising the steps of:
receiving a user upload including an media segment;
receiving a plurality of survey participant feedback reports, wherein each survey participant feedback report includes at least one timestamped indication of the strength with which at least one psychological attribute was felt during a playback of the media segment;
compiling a report regarding the media segment;
receiving a set of parameters regarding a desired media segment;
presenting on a display a dashboard regarding the degree to which the media segment satisfies the set of parameters.

2. The method of claim 1 wherein at least one of the time stamped indications are input to a pie graph graphical user interface.

3. The method of claim 2 wherein the pie graph graphical user interface includes a circular element divided into a plurality of segments, each segment associated with one of the at least one psychological attributes, wherein the selection of an psychological attribute is made by selecting the associated segment, and wherein the indication of strength with which that psychological attribute is felt is determined by the distance from the center of the circular element where the selection was made.

3. The method of claim 1 wherein at least one of the time stamped indications are input to a grid space graphical user interface.

4. The method of claim 1 wherein the media segment is one of a track of music, a voiceover, audio logos or video.

5. The method of claim 1 wherein the survey participant feedback reports are collected by playing the media segment to the survey participants contemporaneously with video.

6. The method of claim 1 wherein the step of compiling a report regarding the media segment includes compiling a set of scores for each of the psychological attributes according to the survey participant feedback reports, and wherein the dashboard shows the respective scores for the psychological attributes for the media segment.

7. The method of claim 6 wherein the scores for each of the psychological attributes for the media segment are weighted with respect to one another according to the number of times the psychological attributes were selected.

8. The method of claim 7 wherein the three most frequently chosen psychological attributes for the media segment are each assigned a unique weighting factor and the remaining psychological attributes are each assigned an equal weight.

9. The method of claim 1 further comprising the steps of:
repeating the steps of receiving a media segment and plurality of survey participant feedback reports and compiling for each a report until at least a plurality of media segments and their associated reports are collected;
receiving a further media segment, wherein a predictive report for the further media segment is determined according to the attributes of the other media segments and their associated reports.

10. The method of claim 1 wherein the determination of the predictive report for the further media is by processing the MFCC of the further media segment, the MFCCs of the other media segments and a vector regarding the scored physiological attributes of the other media segments using a random forest package.

11. The method of claim 1 wherein on the dashboard each psychological attribute is presented as a tile colorized according to the associated score for that psychological attribute.

12. The method of claim 11 wherein the objective data is automatically generated.

13. A method of supporting the selection of a desired media segment from among a plurality of media segments, including the steps of:
storing each of the media segments on a non-transitory storage medium;
regarding a first set of the media segments, receiving a plurality of survey participant feedback reports, wherein each survey participant feedback report includes at least one timestamped indication of the strength with which at least one psychological attribute was felt during a playback of the media segment;
wherein each of the first set of media segments are assigned a numerical score for each of the psychological attributes according to the timestamped indications;
wherein each of the first set of media segments have associated with them a first set of objective data;
receiving a second set of media segments including at least one media segment, wherein each of the media segments of the second set of media segments has associated with it a second set of objective data; and
wherein the second set of objective data is compared to the first set of objective data and the numerical scores associated with the first set of media segments to determine a predictive score for each of the second set of media segments.

14. The method of claim 13 wherein the first set of objective data and second set of objective data are automatically generated.

15. The method of claim 13 wherein the first set of objective data and second set of objective data include one or more of BPM, tone, tempo, what instruments are present and when specific instruments are present in the media segment.

16. The method of claim 13 wherein the first and second sets of media segments are one of tracks of music, voiceovers and audio logos.

17. The method of claim 13 wherein the numerical scores for each of the psychological attributes for the first set of media segment are weighted with respect to one another according to the number of times the psychological attributes were selected.

18. The method of claim 13 wherein the predictive scores for at least one of the second set of media segments are presented on a dashboard.

19. The method of claim 18 wherein on the predictive scores presented on the dashboard are tiles colorized according to the associated predictive scores.

20. The method of claim 1 wherein on the dashboard each psychological attribute is presented as a tile colorized according to the associated score for that psychological attribute.

21. A method of predictively coding media segments, including the steps of:
storing a first and second set of media segments on a non-transitory storage medium;
for each media segment of the first and second set of media segments:
subdividing the media segment into a set of sub-segments,
individually feeding data defining each sub-segment into a SHA-1 hash function and truncating the resultant sub-segment hash to arrive at a set of truncated sub-segment hashes associated with each media segment;
comparing the set of truncated sub-segment hashes associated with a selected one of the second set of media segments with the truncated sub-segment hashes associated with each of the first set of media segments;
identifying at least one of the second set of media segments as similar to the selected media segment according to the number of truncated sub-segment hashes of the similar media segments that match the truncated sub-segment hashes of the selected media segment.
